(19) United States
(12) Patent Application Publication
(10) Pub. No.: US 2004/0229677 A1
(43) Pub. Date: Nov. 18, 2004

(54) Gaming system and method

(76) Inventors: Andrew Patrick Gray, West Yorkshire (GB); John L. Cadigan, Hudson, MA (US); Richard G. Finocchio, Everett, MA (US)

Correspondence Address: Thomas F. Bergert, Williams Mullen PC, Suite 700, 8270 Greensboro Drive, McLean, VA, 22102, US

(21) Appl. No.: 10/438,767

(22) Filed: May 15, 2003

(51) Int. Cl. A63F 13/00

(52) U.S. Cl. 463/17

(57) ABSTRACT

A system and method for playing a wagering game over a network such as the Internet includes a point of sale terminal for issuing a gaming ticket including gaming information to a player. A gaming engine processes ticket results and provides an interactive gaming interface display. A user device displays the gaming interface made available by the gaming engine and permits the user to interact with the gaming engine upon entering the gaming information from the ticket. The gaming engine further obtains and transmits winning information and game results to the player for display on the user device. The game ticket can be validated and redeemed at a point of sale terminal.

### FIELD OF THE INVENTION

The present invention relates to gaming, and in particular, to a gaming system and method in which players can experience wagering games such as instant-type lottery games over a network such as the Internet.

### BACKGROUND OF THE INVENTION

Wagering games played over a publicly-accessible network such as the Internet allow players to participate in high-paced and high-stake games without having to be present at an established gaming location or casino. However, because online gaming is not legal in many jurisdictions, gaming facilities and lottery providers are somewhat hindered in their ability to exploit the Internet's distribution efficiencies. Legal restrictions also limit a player's ability to realize enhanced play capabilities afforded by electronic and Internet-related technologies. Additionally, because many online wagering games require a player to submit personal payment information over a network, many would-be players are hesitant to play such games.

### SUMMARY OF THE INVENTION

By the present invention, there is provided a system and method for playing a wagering game over a network such as the Internet. A point of sale terminal in connection with the present invention issues a gaming ticket including gaming information to a player. A gaming engine processes ticket results and provides an interactive gaming interface display. A user device displays the gaming interface made available by the gaming engine and permits the user to interact with the gaming engine upon entering the gaming information from the ticket. The gaming engine further obtains and transmits winning information and game results to the player for display on the user device. The game ticket can be validated and redeemed at a point of sale terminal.

The present invention allows players to play wagering games from any of a large number of locations over a publicly-accessible network. The present invention further allows players to purchase gaming tickets for multiple plays of a portfolio of games. The present invention further allows players to purchase gaming tickets anonymously in advance from network-connected point of sale terminals, without having to provide payment information over an unsecured network. In one embodiment, the system of the present invention provides a gaming processor for storing the gaming information and for verifying winning gaming tickets. In another embodiment, the gaming ticket can include security information and/or a network address corresponding to the address for a server which can present game displays and game reveal displays.

Other features and advantages of the invention will become apparent from the following detailed description, and from the claims.

### BRIEF DESCRIPTION OF THE DRAWINGS

FIG. 1 diagrammatically shows a system for playing a wagering game in accordance with one embodiment of the present invention.

FIG. 2 shows a ticket used to play a wagering game in accordance with one embodiment of the present invention.

FIGS. 3 and 4 show individual embodiments of interactive gaming interface displays for use in connection with the gaming system of the present invention.

FIG. 5 is a flow chart showing the steps of playing a wagering game in accordance with one embodiment of the present invention.

FIG. 6 is a chart representing pre-determined outcomes in connection with a multi-tiered embodiment of the present invention.

### DESCRIPTION OF THE PREFERRED EMBODIMENTS

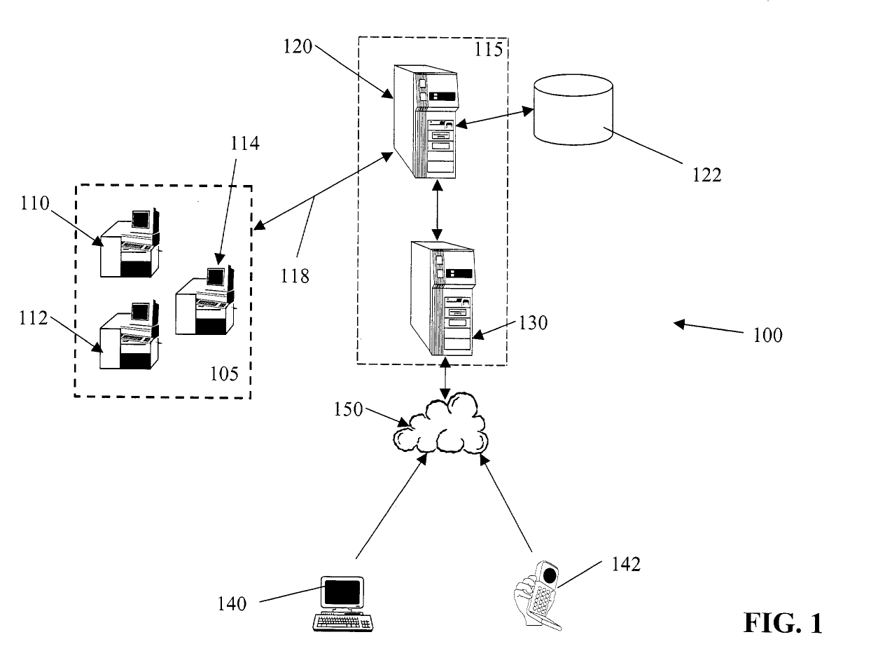

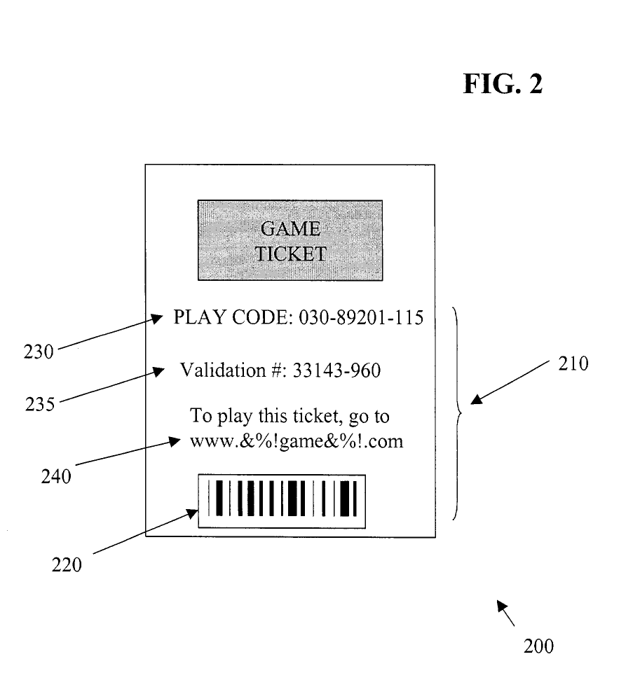

As shown in FIG. 1, a system 100 for playing a wagering game in accordance with the present invention includes one or more point of sale terminals 110, 112, 114 in communication with a central gaming engine 120. The point of sale terminals may be used to purchase a gaming ticket 200 (FIG. 2) and may be part of a wide area network 105 of similar terminals. For example, point of sale terminals 110, 112, 114 may be located at retail establishments and operated/regulated by gaming agents. Terminals can conduct cash or credit transactions in exchange for gaming tickets, and can redeem and validate issued and authenticated tickets. In one embodiment of the invention, the terminal can be programmed to establish, deduct from and add to one or more wagering accounts maintained with the retail establishment or gaming provider. The terminal can be manned by human personnel or can be a stand-alone, self-service kiosk.

Point of sale terminal is capable of printing gaming tickets upon a player's request. Point of sale terminal may include equipment and programming as is well known in the art, including a keyboard for entering wager requests, a screen or display for displaying wagering requests and gaming information, a microprocessor for processing wager requests and gaming information, a printer for printing gaming information on gaming tickets, and a modem or other communications device for communicating digitally or otherwise with central gaming processor 120 to transmit wagering requests and wagering information and to receive wager verification information.

Central gaming processor 120 may be located remotely from any of point of sale terminals 110, 112, 114, and may be connected directly or indirectly to the point of sale terminals over a secure communication link such as a secure network connection (e.g., 118). Central gaming processor 120 may include a database 122 which stores wagering information for each wager request made at point of sale terminals 110, 112, 114 and an outcome indication for each wager request to ensure accurate and detailed recordation of players' wagering activity.

Gaming processor includes associated memory and processing means for executing a gaming program. The gaming program produces ticket and individual game outcomes associated with tickets, and attributes the outcomes to individually issued tickets from point-of-sale terminals, for example. All information relevant to the produced ticket is stored in database 122 for validation and authentication purposes, and to enable game server to properly reveal outcomes when the user plays the individual game plays. In one embodiment, the gaming program can generate a random outcome data stream having a finite series of binary (e.g., win/lose) outcomes, wherein the finite number is based on the number of plays purchased by a user on a given ticket. Thus, for example, a 10-play ticket may have the outcomes of: 0, 0, 0, $2, 0, $5, 0, 0, 0, 0. The ticket outcome would be $7 in this example, while the individual game play outcomes would be as stated in the series. The ticket outcome and the individual game play outcomes are all pre-determined prior to the user revealing a game play on a user device. Individual outcome payouts can be determined randomly according to established gaming provider methods, such as, for example, aggregating all winning outcomes as a predetermined percentage payout of the total revenues generated by ticket sales.

As further shown in FIG. 1, the gaming result information can be found on an interface or Internet web page generated by a gaming server 130, which can be in communication with central gaming processor 120. Server 130 can be a typical Internet web site server or similar device capable of producing an interface that is communicated to user devices 140, 142 over network 150. Network 150 can be the Internet or any communications network such as a dial-up, hard-wired or wireless digital network. Server 130 can also communicate with central gaming processor 120, e.g., over a secure data communications link or a secure network, to obtain gaming interface information for display of the game on user devices 140, 142. Processor 120 and server 130 can together comprise a gaming engine 115 in connection with the present invention.

It will be appreciated that devices 140, 142 can be any of a wide range of computing devices capable of accepting input and displaying text, graphics, and even animation and video. Such devices can include personal computers, wireless phones, and other mobile devices, such as laptops and personal digital assistants, for example. Each device is preferably provided with a microprocessor, a screen or a monitor, and a modem for communications over network 150, and may optionally be provided with a keyboard or keypad for entering information, and a mouse for moving a cursor on screen and for clicking on a particular location on the screen.

A gaming ticket 200 is shown in FIG. 2. Gaming ticket 200 can be purchased from an on-line point of sale terminal 110. Ticket 200 may be a printed paper card or a rewritable, erasable, and reusable plastic card. Ticket 200 may be purchased for a predetermined number of advance game plays. A player may purchase ticket 200 to play a wagering game a predetermined number of times per day for a predetermined number of days. For example, to place a wager of 10 cents for each game of a wagering game that will be played 10 times per day over a period of ten days, the purchase price of the ticket would be $10.

Ticket 200 includes variable gaming information 210 to assist in the play and enforcement of the wagering game. For example, as shown in FIG. 2, gaming information 210 on ticket 200 can include a barcode 220, an identification number 230, a validation number 235 and a web site address or URL 240 designating a web address at which the user can play the wagering game in connection with the present invention. In one embodiment of the invention, the ticket is re-usable and can be used to store more permanent information including the user's contact information and security or password information. The user can use the game card identification code or number 230 to log in to the gaming server and play a wagering game in connection with the present invention. The validation code 235 can be used by a point-of-sale attendant when the user is attempting to validate and redeem the ticket. Additional security information, as well as other information such as the amount of the wager, the dates of the games for which the ticket was purchased, and the location of the point of sale terminal from which the ticket was issued, may be included on the ticket in the form of a machine-readable bar code 220 capable of being read by a bar code reader at a point of sale terminal.

The player can play the wagering game using a specialized gaming display in the form of a screen interface which is produced by server 130 and which is accessed over network 150 using a device as described earlier (e.g., 140, 142). It will be appreciated that the player can maintain anonymity in playing a wagering game using the present invention, as the player need not identify him or herself at any point during the purchase, play or validation of the game. Additionally, a player may purchase a ticket for other players, such that the purchasing player need never play the games associated with a purchased ticket in order to activate, validate or redeem the ticket.

Each specialized game display may be accessed over network 150, e.g., at one or more Internet web sites having a unique web site address. Different game types which can be played in connection with the present invention include, for example, poker and other card games, slot machine-type games, instant scratch games, stock market games, treasure hunt games and other similar instant ticket type games. The player's game results can be presented based on the interface appearing on the screen of the player's device.

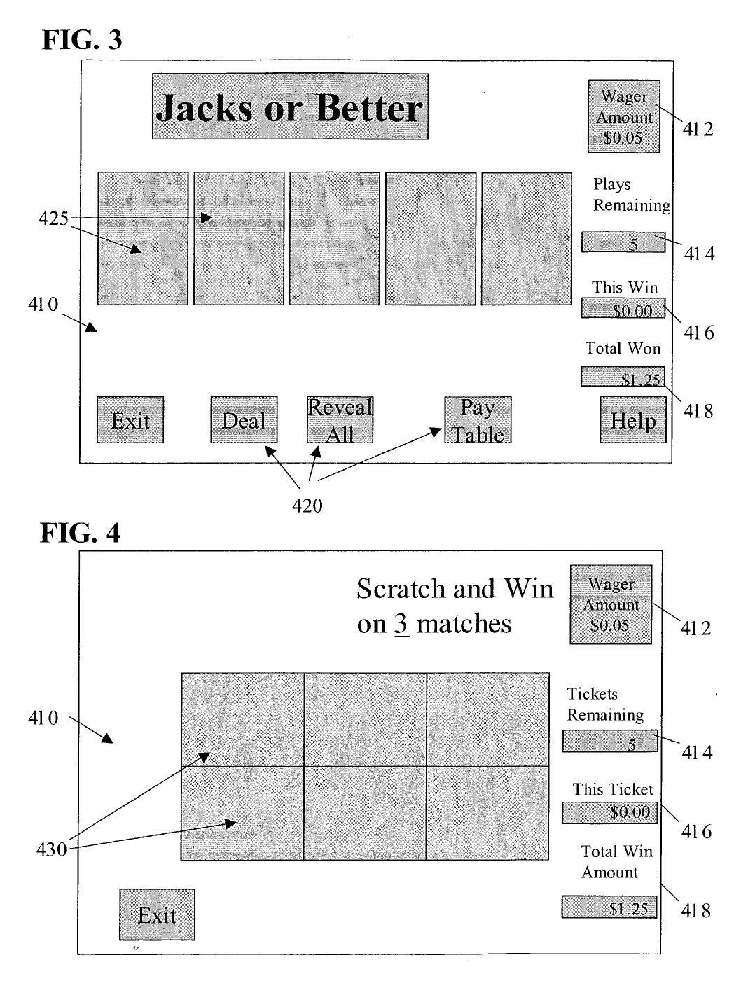

It will be appreciated that for as many game types as are offered by the present invention, there is a corresponding interactive game interface. From the interface, the present invention can receive user instructions and, in the case of a user instruction to play a game, the present invention can manipulate a “reveal” display to show the results of the game play. For example, as shown in FIGS. 3 and 4, there is provided a game play interface display 410. The display corresponds to a selected game. In FIG. 3, the selected game is a card game, while in FIG. 4 the selected game is a scratch-off instant win game. Status information such as wager amount 412, number of plays 414 remaining on the ticket, individual game winnings 416, and total ticket winnings to date 418 can be displayed as shown. The user can instruct play or other game manipulation through selection of various game buttons such as shown at 420. The user can also manipulate interactive game pieces such as cards 425 and scratch areas 430, as shown in FIGS. 3 and 4, respectively.

In one embodiment of the present invention, the user is provided with multiple game options with each game play available on a purchased ticket. For example, the user may desire to play the game “Jacks or Better” over the entire number of game plays available on his or her ticket. Or, the user may desire to split the total number of plays between the “Jacks or Better” game and the “Scratch and Match 3 to Win” game. In the present invention, each of the game play outcomes is determined and established once the user's ticket is purchased. Also, because the value of the ticket is known once the ticket is issued, the user may validate and cash in his or her ticket winnings without ever having played the games associated with the ticket.

The present invention, by allowing the user to reveal results online, gives the user additional opportunities to play wagering games off-site from casinos and other gaming locations. The reveal component in connection with the present invention allows the user to see the results of his or her wager. In one embodiment of the invention, a game payout is pre-determined for each game play associated with a particular ticket. Thus, for example, if it is determined that a given ticket has ten (10) game plays, and game 7 is a $0.25 winner, the user who plays game 7 will win $0.25 regardless of which game is selected.

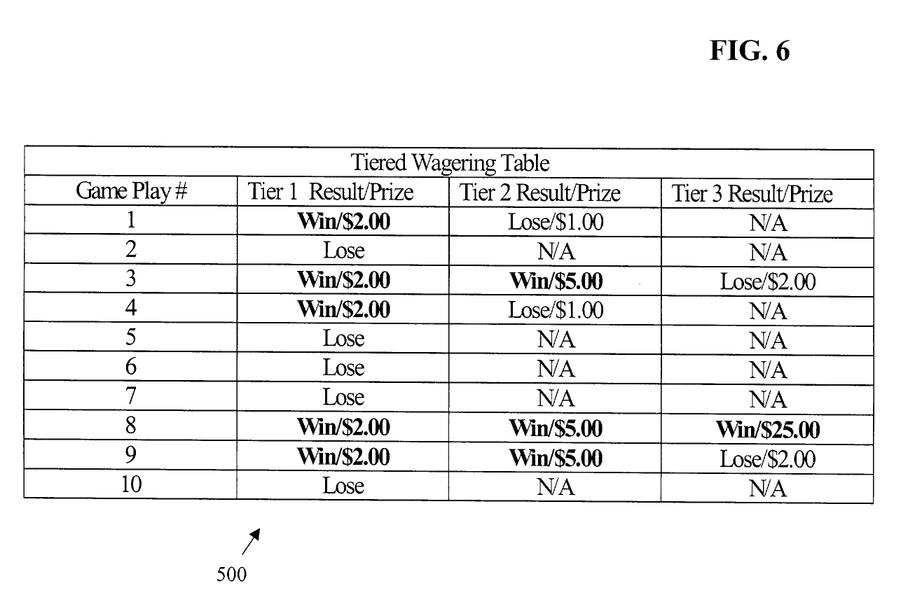

In one embodiment of the invention, the user can be given the opportunity to roll winnings from a previous game play into the next pool. In this way, the reveal component of the present invention is provided with tiers. In this embodiment of the invention, the ticket can represent multiple tiers of game plays, and a player can access the web site to play and reveal results of the gaming ticket within different tiers. Each tier can represent individual pools having different odds and rewards. For example, FIG. 6 illustrates a chart 500 of gaming outcomes for ten tickets to be used in connection with a three-tiered game. Tier 1 can represent a higher-odds, lower-reward pool of games, Tier 2 can represent a moderate-odds, moderate-reward pool of games, and Tier 3 can represent a lower-odds, higher-reward pool of games. All of the outcomes in each tier are predetermined, as previously described. However, the value of the ticket can vary depending on how the user plays the ticket.

In the example of ten ticket plays shown in FIG. 6, the player wins in Tier 1 five times. For these wins, the system of the invention can allow the player to stop and protect the prize won in Tier 1 (e.g., $2.00 in FIG. 6), or the player may decide to pursue a greater prize in Tier 2. Regardless, the gaming ticket still maintains entirely pre-determined outcomes, but provides a variable value depending on the player's selections. If the user wins in Tier 2, he or she may stop and collect the prize for Tier 2 (e.g., $5.00 in FIG. 6), or pursue a greater prize in Tier 3. With each win, the user may stop play on the ticket, knowing that he or she may not be playing the ticket for its full prize value. In one embodiment of the invention, even if the player pursues and loses a higher tier game after a win on a lower tier, the player may be provided with a consolation prize, as opposed to winning nothing. An example of this embodiment is shown in game play 3 in FIG. 6.

In this embodiment, the system of the present invention can track the optional user game plays “on the fly” to determine when a particular pool of game plays has been exhausted. Further, the system of the present invention can update the odds of winning for yet-to-be issued tickets as it learns the number of optional plays which are actually played and the number of tickets redeemed without play of the optional plays. Thus, as an example, once a user redeems his or her ticket and the optional plays stored on the ticket have not been used, the optional play outcomes can be re-entered into the pool of yet-to-be played game plays.

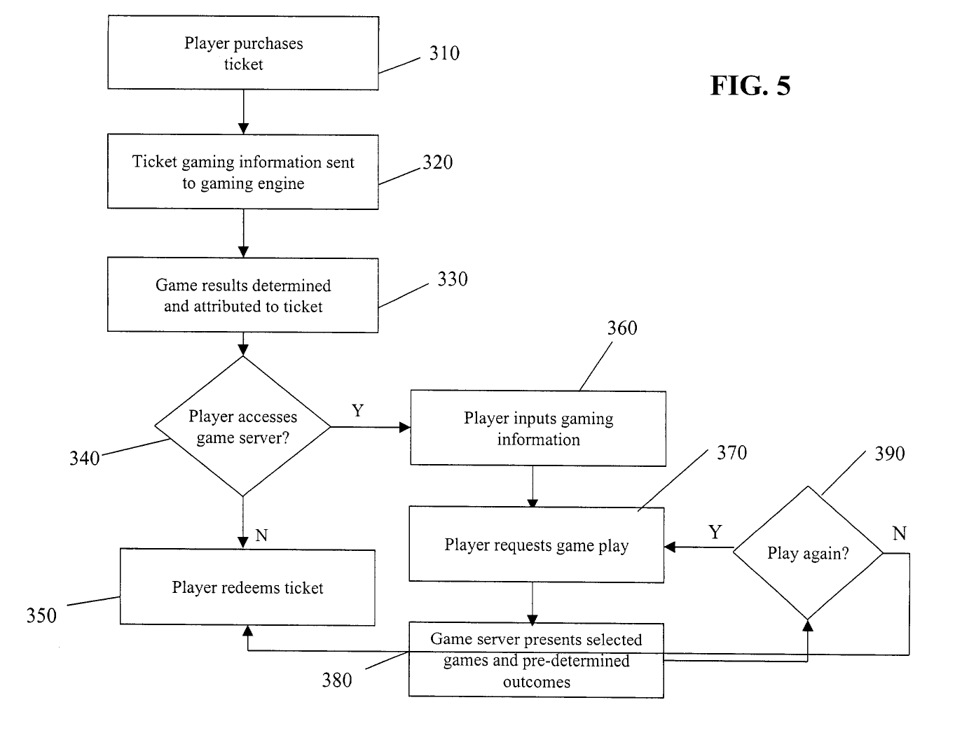

A method of playing the wagering game of the present invention is shown in FIG. 5. As shown at step 310, the player purchases gaming ticket 200 from an on-line point of sale terminal. As at step 320, the ticket information is processed in accordance with gaming rules and can be sent to central gaming processor 120 to be stored in database 122. The gaming information stored in database 122 may be accessed at any time, whether the ticket game plays have been revealed or not, to verify that the ticket is a winning ticket. Game results are determined according to programming associated with the gaming processor and attributed to the ticket as at step 330. The game results include outcome information for the entire ticket as well as for individual game plays associated with the ticket. Game results can also be stored in database 122.

The player can then determine, as at step 340, whether to access the game server or simply validate and redeem the ticket without playing the games, as at step 350. If the player chooses to play and reveal the ticket outcome(s), the player can access the network-available site and enter the gaming information from the ticket, as at step 360. As at step 370, the player can select a game for playing one of the game plays on the ticket, and can request the outcome of the selected game. As at step 380, the gaming engine can present the selected game for display and the pre-determined outcome associated with the ticket as determined by gaming processor 120. At any time, including prior to revealing all game play results, the user can validate and redeem the full amount of the ticket, as at 350. Alternatively, the user can decide, as at 390, to repeat play for as many game plays as are available in connection with the ticket. For each repeated game play, the gaming engine can present the user-selected game for display as well as the revealed outcome on the user's device.

The purchase and redemption of physical tickets at a point of sale terminal such as a retail terminal assists in the overall security and anonymity afforded by the present system, while the presentation of a plurality of game options and reveal displays preserves the “casino feel” for the user.

In one embodiment of the present invention, the user's device can download game play combinations for the allotted number of game plays and associated outcomes available in connection with the ticket. In this way, the user's device does not need to be connected to the network to play the available games. For example, if two games are available for play in connection with a given ticket, and the ticket has 50 plays, the user can first login to the game using the gaming information from the ticket. Upon verifying the user's ticket information, the gaming engine can recall the previously determined ticket outcome and the individual game play outcomes, and can send the outcomes and various reveal displays associated with both available games to the user's device. Once the user selects a game type for individual game play, programming on the user's device can reveal the pre-determined outcome associated with the game play for the selected game type. Thus, if there are fifty game plays and two game types available, for example, the user may reveal all fifty game plays on the first game type, the second game type, or on any combination and sequence of the first and second game types. The winning and losing reveals can be displayed in connection with either game type for any game play. In this way, the user can vary the game type being played and thus the game play enjoyment, even though the results have been pre-determined.

As at step 350, the player may redeem the ticket for the corresponding prizes or money winnings. For example, the player may surrender the ticket to an agent operating an on-line point of sale terminal which communicates with central gaming processor 120 to verify that the ticket is a winning ticket based on a stored indication of winning status, and the agent then gives the player the corresponding prizes or money winnings.

The invention may be embodied in other specific forms without departing from the spirit or essential characteristics thereof. The present embodiments are therefore to be considered in all respects as illustrative and not restrictive, the scope of the invention being indicated by the claims of the application rather than by the foregoing description, and all changes which come within the meaning and range of equivalency of the claims are therefore intended to be embraced therein.

What is claimed is:

1. A method for conducting a wagering game, comprising the steps of:
receiving a payment from a player at a point-of-sale terminal;
issuing a ticket from said point-of-sale terminal, said ticket having gaming information thereupon;
computing a game result associated with said ticket;
receiving said gaming information and a game delivery request from said player via a user device;
in response to said request, providing an interactive game interface for display on said user device;
receiving at least one game play signal from said player; and
in response to said received signal, presenting information corresponding to said game result on said user device.

2. The method of claim 1 including the further step of receiving a validation request from said player at a point-of-sale terminal, said request including presentment of said ticket.

3. The method of claim 1 wherein said information corresponding to said game result includes a result for said at least one game play.

4. The method of claim 1 wherein said ticket includes a plurality of game plays and said game result includes a plurality of game results corresponding to the number of game plays included on said ticket.

5. The method of claim 1 further including the step of storing said game result and said ticket gaming information on a network device.

6. The method of claim 1 wherein said payment is a cash payment.

7. The method of claim 1 wherein said player chooses said game interface for display.

8. The method of claim 1 wherein said game delivery request is received and said information corresponding to said game result is presented by a gaming engine accessed over a network.

9. The method of claim 2 including the further step of attributing winnings from said validation request as payment for at least one additional game using said ticket.

10. The method of claim 2 including the further step of depositing winnings from said validation request into a deposit account for said user.

11. A gaming system, comprising:
a receiver component for receiving a wager payment and for issuing a ticket having gaming information thereupon;
a gaming engine in communication with said receiver component for computing a game result associated with said ticket and for providing at least one interactive game interface display;
an input component for receiving said ticket gaming information and at least one game play signal from a user, said input component having a display component for presenting said game interface display from said gaming engine and a reveal component for presenting information corresponding to said game result.

12. The system of claim 11 wherein said ticket includes a plurality of game plays and said game result includes a plurality of game results corresponding to the number of game plays included on said ticket.

13. A method of providing results to a wagering game, comprising the steps of:
issuing a ticket to a game player, said ticket having gaming information thereupon;
determining results for at least one game play associated with said ticket;
providing a plurality of interactive game interfaces capable of display on a user device;
receiving a selection of a game interface from a user and displaying said selected interface;
receiving a request from said user via said user device for a game play;
determining whether said requested game play is a winner; and
presenting a reveal display within said selected game interface.

14. The method of claim 13 including the further step of, upon said game play being determined a winner, determining a payout associated with said game play and displaying said payout.

15. The method of claim 13 wherein said user is said player.

16. The method of claim 13 wherein said user is not said player.

17. The method of claim 13 wherein said user device is a device taken from the group of devices comprising: a personal computer, a personal digital assistant, a wireless phone.

18. The method of claim 13 including the further step of providing said user with an option to roll over winnings from at least one game to a next game occurring after said at least one game.

19. The method of claim 13 wherein said ticket is issued from a point-of-sale terminal.

20. The method of claim 13 wherein said ticket is not issued from a point-of-sale terminal.

21. A system for providing outcomes to a wagering game, comprising:
means for receiving a payment;
means for issuing a ticket in response to said payment, said ticket having gaming information thereupon in connection with at least one game play;
means for determining outcomes for said ticket and said at least one game play;
means for providing a plurality of interactive game interfaces capable of display on a user device;
means for receiving a selection of a game interface from a user and displaying said selected interface;
means for receiving a request from said user via said user device for a game play;
means for determining whether said requested game play is a winner; and
means for revealing said at least one game play outcome within said selected game interface.

22. The system of claim 21 wherein, upon said winner determining means determining said requested game play to be a winner, and upon said game play winner being revealed to said user, further including means for providing said user with the option of extending said winner game play into an additional game play request.

23. A method for conducting a wagering game, comprising the steps of:
providing a game ticket representing a plurality of game plays;
determining a game play payout for each of said plurality of game plays;
upon receiving a request to reveal a game result associated with at least one of said game plays, revealing said game result and said determined game play payout for said at least one game play.

24. The method of claim 23 wherein said game ticket is provided by a point-of-sale terminal and said request is received via a user device communicating via a network, said user device not being in communication with said point-of-sale terminal.

25. The method of claim 23 wherein said reveal request includes a game display request taken from a selectable menu of game display options.

26. A method for conducting a wagering game, comprising the steps of:
receiving a cash payment at a first point-of-sale terminal;
providing a game ticket representing a plurality of game plays;
providing a plurality of interactive game interface displays accessible to a user over a network via remote device; and
redeeming said ticket at a second point-of-sale terminal.

27. A gaming system, comprising:
a point-of-sale device for receiving wager payment from a user and issuing at least one gaming ticket, said gaming ticket having gaming information;
a gaming engine in communication with said point-of-sale device for computing and storing gaming results associated with said at least one ticket, said gaming engine further being capable of providing a plurality of interactive game interface displays, determining game play outcomes, and presenting reveal display information; and
a user device in communication with said gaming engine for requesting a game play using said gaming information and for displaying said interactive game interface displays and said reveal display information.

28. In a system for playing wagering games online, where ticket information representing known individual game outcomes can be used by a player to access interactive game displays and game outcome displays from a remote device over a network, a gaming engine comprising:
associated memory and processing means for executing at least one gaming program from said associated memory, said processing means executing said at least one gaming program to randomly generate said individual game play outcomes, to associate said outcomes with said ticket information, to present a menu of interactive game types and to enable said player to select an interactive game type for playing individual game plays and further enable said player to reveal said individual game play outcomes.
